(19) United States
(12) Patent Application Publication
(10) Pub. No.: US 2015/0173482 A1
(43) Pub. Date: Jun. 25, 2015

(54) COMB

(71) Applicant: KONINKLIJKE PHILIPS N.V., EINDHOVEN (NL)

(72) Inventors: Bin Yin, Eindhoven (NL); Xiaoxin Want, Eindhoven (NL)

(21) Appl. No.: 14/408,451

(22) PCT Filed: Jun. 19, 2013
(86) PCT No.: PCT/IB2013/055029

§ 371 Date: Dec. 16, 2014

(30) Foreign Application Priority Data
Jun. 20, 2012 (CN) PCT/CN2012/077230

(51) Int. Cl. A45D 24/30; A45D 24/10; F21V 33/00

(52) U.S. Cl. CPC A45D 24/30; F21V 33/004; A45D 24/10

(57) ABSTRACT

The present invention related to a comb, said comb comprising a body, a tine extending from said body, said tine being covered or partially covered by photocatalytic material, and a light source positioned in said comb, said light source providing light beams to the surface of said photocatalytic material to accelerate reactions of generating radicals from air. This solution makes Chair washing easy for users, for example women during pregnancy and after childbirth. It would also be advantageous to provide a solution which enables effective hair washing without use of shampoo.

### TECHNICAL FIELD

The invention relates to a comb, and particularly to a comb for removing dirt from hair.

### BACKGROUND OF THE INVENTION

Good hair hygiene is important in keeping hair healthy as well as reducing discomfort and embarrassment caused by oily hair and itchy scalp. The hair washing procedure typically involves wetting the hair, applying shampoo, rinsing, and drying.

However such procedure can be hard for women during pregnancy, because it usually requires postures like bending forward or back which are difficult for pregnant women to fulfill especially during their final trimesters. Such procedure can also be hard for women after childbirth who may have difficulty leaving bed due to blood loss, vaginal rupture, Cesarean section, etc. In some countries, for example China, women are suggested not touching chemicals or water for personal hygiene purposes within the first month after childbirth.

In addition, people living the ‘no-poo’ lifestyle reject the societal norm of daily or almost daily shampoo use, with the purpose of reducing chemical use that is harmful for both the environment and human health. Some of them use baking soda or vinegar to wash their hair and some others use nothing, rinsing their hair only with warm water, the cleaning outcome of which is apparently not optimal.

Koon-Chi Kwan, U.S. Pat. No. 6,053,180 discloses a hair styling appliance incorporating a 15V light emitting source so that as the hair is being styled, the hair, the scalp as well as the appliance itself can be disinfected. The UV light is used to kill microorganisms including spores, virus, fungus, bacteria and lice.

### SUMMARY OF THE INVENTION

The inventor of the present invention has recognized that conventional hair appliances do not provide a solution for problems arising from hindrances to or unwillingness in the hair washing procedure which typically involves wetting the hair, applying shampoo, rinsing, and drying.

It would therefore be desirable to provide a solution which makes hair washing easy for users, for example women during pregnancy and after childbirth. It would also be advantageous to provide a solution which enables effective hair washing without use of shampoo.

To better address one or more of these concerns, in one embodiment of one aspect of the present invention, there is provided a comb, comprising:

a body;

a tine extending from the body, the tine being covered or partially covered by photocatalytic material, and

a light source positioned in the comb, the light source providing light beams to the surface of the photocatalytic material to accelerate reactions of generating radicals from air.

The basic idea is to degrade the dirt on hair shaft and scalp from hydrophobic substances to hydrophilic ones with radicals, which are generated from certain molecules in the air, such as water (H₂O) and/or oxygen (O₂), by irradiating the surface of photocatalytic materials with light beams of suitable wavelength. Specifically, the photocatalytic material creates electron-hole pairs when photo-excited by light beams. The electron-hole pairs react with certain molecules, such as water and/or oxygen, incorporated in the air. As a result, radicals are generated. The radicals, being very oxidative in nature, can oxidize the dirt on hair shaft and scalp, resulting in hydrophilic substances which can be removed with very little water or just by wiping. In this way, the dirt on hair shaft and scalp can be removed easily and without using shampoo.

Optionally, the comb comprises a plurality of tines being covered or partially covered by photocatalytic material. When irradiated by the light beams from the light source, the plurality of tines collectively provide radicals to the hair.

In one embodiment of another aspect of the present invention, there is provided a method of removing dirt from hair, comprising the steps of:
accelerating reactions of generating radicals from air by providing light beams to photocatalytic material;
applying the radicals to the hair to degrade the dirt; and
drying the hair.

These and other features, aspects, and advantages of the invention will be apparent from and elucidated with reference to the embodiment(s) described hereinafter.

### BRIEF DESCRIPTION OF THE DRAWINGS

The above and other objects, characteristics and merits of the present invention will become more apparent from the following detailed description considered in connection with the accompanying drawings, in which:

FIG. 1 depicts a schematic cross-sectional diagram of a comb according to an embodiment of the present invention;

FIG. 2 depicts a schematic cross-sectional diagram of a comb according to a variation of the embodiment of FIG. 1;

FIG. 3 depicts a schematic diagram of a comb according to another variation of the embodiment of FIG. 1;

FIG. 4 depicts a schematic diagram of a comb according to another embodiment of the present invention;

FIG. 5 depicts a schematic diagram of a comb according to yet another embodiment of the present invention;

FIG. 6 depicts a schematic diagram of a comb according to yet another embodiment of the present invention; and

FIG. 7 depicts a flow chart of a method according to an embodiment of the present invention,

wherein same or analogous reference numerals are used to represent same or analogous step features/devices (modules) throughout the figures.

### DETAILED DESCRIPTION OF THE EMBODIMENTS

Reference will now be made to embodiments of the invention, one or more examples of which are illustrated in the figures. The embodiments are provided by way of explanation of the invention, and are not meant as a limitation of the invention. For example, features illustrated or described as part of one embodiment may be used with another embodiment to yield still a further embodiment. It is intended that the present invention encompass these and other modifications and variations as come within the scope and spirit of the invention.

As it is used in this description, “dirt” on hair and scalp generally refers substances that make hair and scalp become dirty, including, for example, sebum, dandruff and dust.

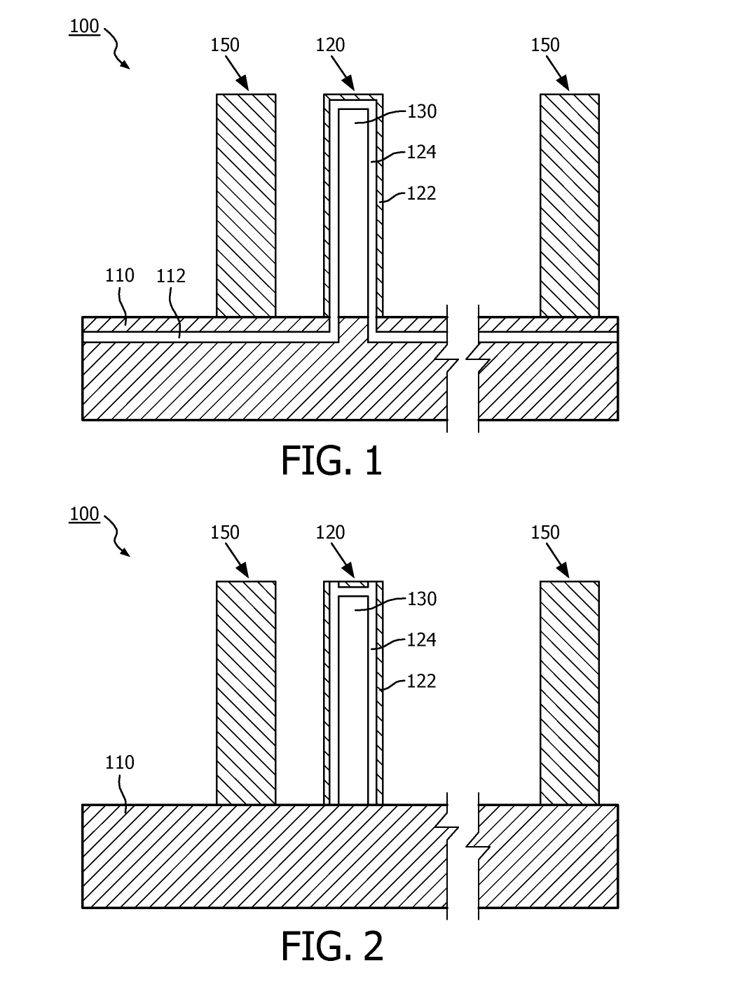

FIG. 1 depicts a schematic cross-sectional diagram of a comb 100 according to an embodiment of the present invention, comprising a body 110, a tine 120 and a light source 130 positioned in the tine 120.

The body 110 has a function of handle and housing a power supply to power the light source 130, control electronics, and other auxiliary components known in the art. The power supply can be implemented with a battery, a transformer to be connected to an electrical outlet, or any other suitable means. The control electronics can be configured to control the function of the comb 100 based on user's operations. For example, the control electronics electrically connect the light source 130 to the power supply in response to the user pressing a power button (not shown) disposed on the body 110. For another example, the control electronics have the function of providing different voltage levels to the light source 130 and thereby control the intensity of the light source 130. Additional features can include over current protection, short circuit protection, etc. The construction and implementation of the power supply and control electronics are known to the skilled in the art and will not be elaborated here, for purpose of brevity.

The tine 120 is covered by photocatalytic material 122. Suitable photocatalytic material 122 may include TiO₂, ZnO, CeO₂, ZnO₂, SnO₂, SbO₄, CdS, ZnS or combinations thereof. Examplary manufacturing process for the tine 120 will be described later.

The light source 130 positioned in the tine 120 is for providing light beams, preferably with wavelength shorter than 400 nm, to the surface of the photocatalytic material 122. For this purpose, as shown in FIG. 1, the comb 100 further comprises an air channel 124 positioned between the inner surface of the photocatalytic material 122 and the light source 130. The air channel 124 is made to be in open communication with an air channel 112 in the body 110, thereby the air channel 124 is connected to the exterior, permitting air to exist between the inner surface of the photocatalytic material 122 and the light source 130. As a result, photocatalysis takes place at the inner surfaces of the photocatalytic material 122, and hydroxyl radicals are produced by the reaction of photo-excited photocatalytic material 122 and certain molecule(s) incorporated in the air, for example, water and/or oxygen. The air channel 124 can have a submillimeter width, for example, 100 microns, 200 microns or any other suitable width.

A variety of radiation sources including, for example, diode lasers, vertical cavity surface emitting lasers (VCSELs), or light emitting diodes (LED), can be used to implement the light source 130. Preferably, the light source 130 comprises at least one organic light emitting diode (OLED) incorporating a flexible plastic substrate on which the electroluminescent organic semiconductor is deposited. In this way, the tine 120 is bendable and therefore gentle to hair and scalp, minimizing any pulling or tearing of hair.

The comb 100 comprising the tine 120 can be manufactured using various technologies. In an exemplary manufacturing process, injection molding is applied. Prior to injecting polymer melt into the mold, the light source 130 is placed in position. In the injection molding process, pre-placed inserts enables formation of air channels 122 and 112 as is known to the skilled in the art. The normal tines 150 of the comb 100, generally in the form of solid plastic rods, can be formed simultaneously with the tine 120. After demolding, photocatalytic material 122 is coated over the tine 120 by spraying, dip coating, or any other suitable coating technologies. It will be noted that other methods for manufacturing the comb 100 known to the skilled in the art may be utilized as well.

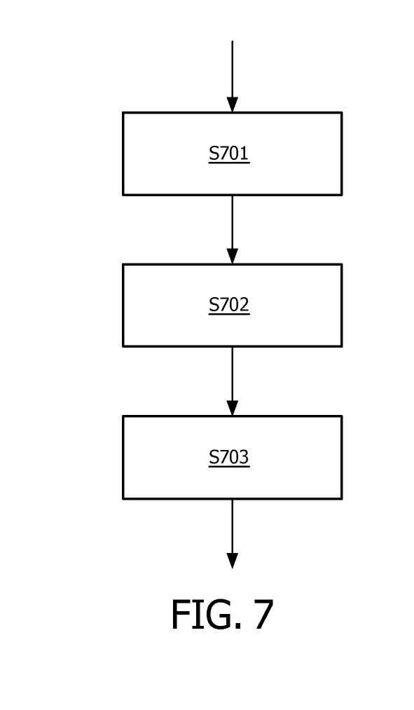

The operation of the comb 100 will now be described with reference to FIG. 7, which depicts a flow chart of a method according to an embodiment of the present invention.

In step S701, photocatalytic reactions of generating radicals from air is accelerated by providing light beams, preferably with a wavelength shorter than 400 nm, to photocatalytic material.

Specifically, the light source 130 emits light beams, preferably with a wavelength shorter than 400 nm, when the comb 100 is powered on. Once irradiated by light beams, the photocatalytic material 122 generates electron-hole pairs. In detail, the electron present in the valence band is excited by photon of the light beams and jumps from the valence band to the conduction band, as result of it, a positive hole is generated. The positive hole reacts with the water vapor in the air and produces hydroxyl radicals (—OH), and meanwhile the negative electron reacts with oxygen in the air and produces superoxide radicals (O₂).

It will be noted that, in order to excite the electron from the valence band to the conduction band, the energy of the photon should be equal to or greater than the band gap energy of the photocatalytic material 122. For this purpose, light beams with a wavelength shorter than 400 nm, i.e., covering the ultraviolet spectrum and the X-ray spectrum, is applicable.

In step S702, the radicals generated in step S701 is applied to the hair to degrade the dirt. To this end, the comb 100 is placed on the scalp after it is powered on, and pulled through the hair so as to make the radicals be in good contact with the dirt. As is known, dirt on hair shaft and scalp generally includes sebum, dandruff and dust, most of which are hydrophobic. Because of being very oxidative in nature, the hydroxyl radicals can oxidize the dirt, resulting in hydrophilic substances which can be removed easily with very little water or just by wiping.

In step S703, the hair is dried by means of, for example, wiping or air drying.

It will be noted that the steps S701 and S702 can be performed simultaneously or alternately.

One or more of the following advantages may be realized by employing the comb 100 of FIG. 1 and/or the method of FIG. 7:

First, the comb 100 (the method of FIG. 7) is easy and convenient to use because it only requires simple operations, such as combing and wiping, during hair washing. This is especially advantageous to users like women during pregnancy or after childbirth who have difficulty in fulfilling postures such as bending forward or back.

In addition, washing hair with the comb 100 (the method of FIG. 7) doesn't require use of shampoo which is good for both the environment and user health.

In one example, the photocatalytic material 122 is configured to have a micro optical grating structure, which prevents the light beams from passing through, whilst permits radicals to be released to the outside. In this way, possible damage on hair and scalp caused by the light beams, if any, is avoided.

It will be noted that the tine 120 may be implemented in various constructions.

FIG. 2 depicts a schematic cross-sectional diagram of a comb according to a variation of the embodiment of FIG. 1. As shown in FIG. 2, the air channel 224 is in direct communication with the exterior, which permits air to exist between the inner surface of the photocatalytic material 122 and the light source 130. To prevent hair from getting caught therein, the air channel 224 can have a width of less than the diameter of human hair, for example, 10 microns, 20 microns, or any other suitable width.

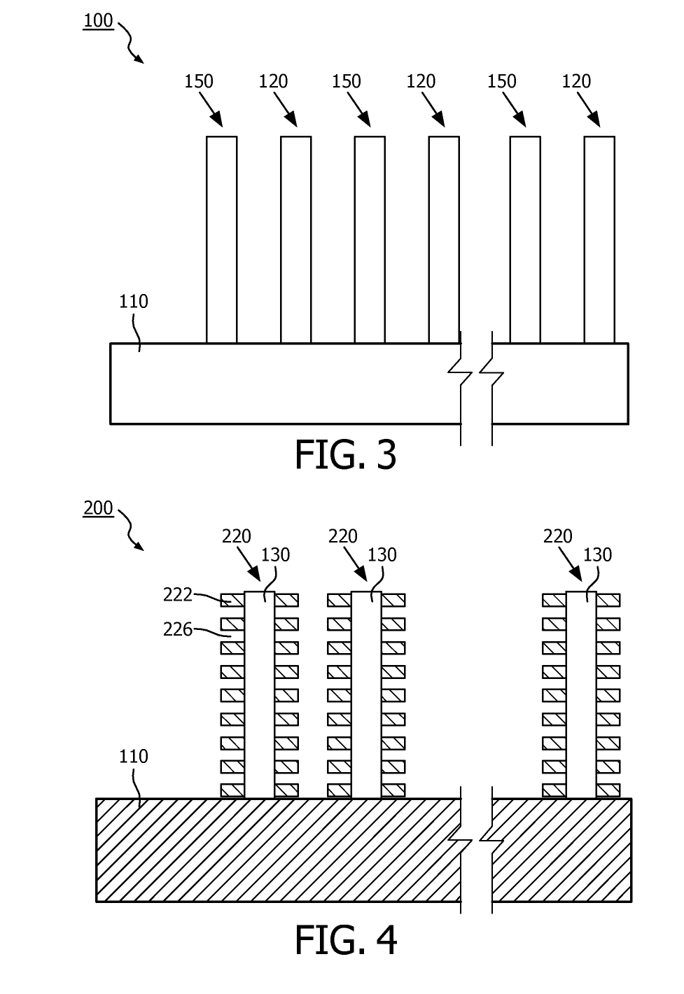

In FIGS. 1 and 2, the comb 100 is shown to have one tine 120. It will be noted that the comb 100 can have a plurality of tines 120. The ratio of the number of tines 120 to the number of normal tines 150 can be varied according to practical needs. FIG. 3 shows an example comb 100 having the same number of tines 120 and tines 150, which are arranged in an alternating manner.

FIG. 4 depicts a schematic diagram of a comb 200 according to another embodiment of the present invention. As is shown, the photocatalytic material 222 comprises a plurality of openings 226. Such openings 226 permit light beams from the light source 130 to pass through, and also permit air to reach the surface of the photocatalytic material 222. Thus, photocatalysis takes place at the surfaces of the photocatalytic material 222 surrounding the openings 226. As a result, hydroxyl radicals are produced by the reaction of photo-excited photocatalytic material 222 and water incorporated in the air.

It will be noted that the openings 226 can be sized to prevent hair from getting caught therein. For example, the openings 226 may have a width of about 20 microns, which is smaller than the diameter of human hair.

The comb 200 comprising the tines 220 can be manufactured by various technologies. In one example, the light source 130 is provided in the form of a tube comprising an elastic and transparent wall housing an OLED array. First, a continuous photocatalytic material is coated over the light source 130. Afterwards, a mask, for example a patterned polymer mask, is formed on the photocatalytic material. Then an etching process is used to remove the portion uncovered by the mask. In this way, photocatalytic material 222 with openings 226 is obtained. In another example, the photocatalytic material 222 is implemented as TiO₂ nanowires. It will be noted that other methods for manufacturing the comb 200 known to the skilled in the art may be utilized as well.

In addition to the advantages that can be realized by the comb 100, the comb 200 can provide a high specific surface area of the photocatalytic material 222. In other words, the comb 200 can generate more radicals per unit of mass.

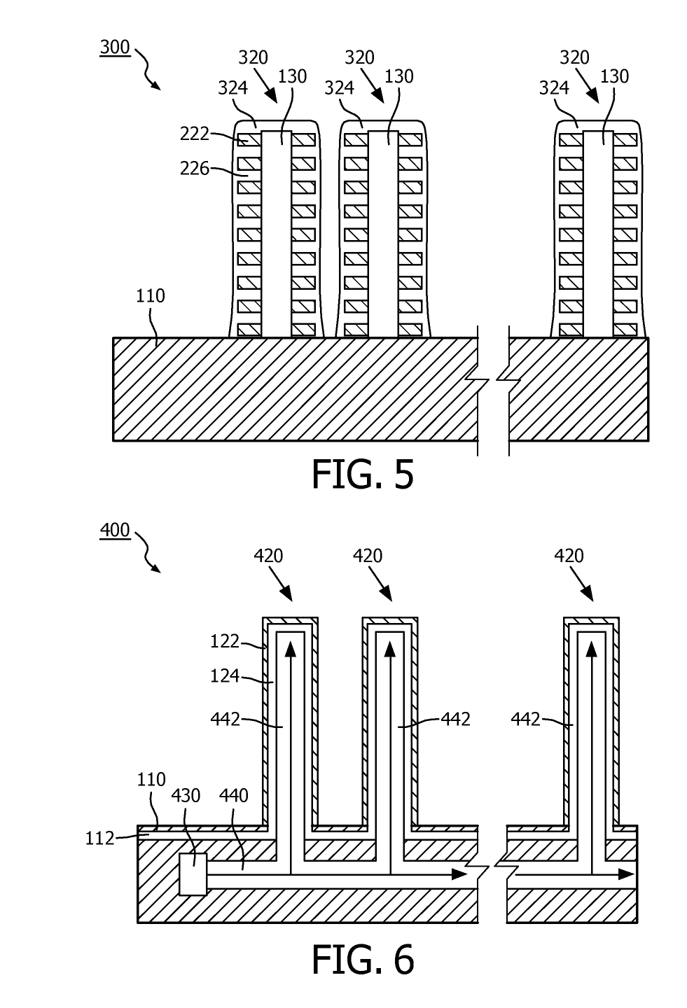

FIG. 5 depicts a schematic diagram of a comb 300 according to yet another embodiment of the present invention. In comparison with the comb 200, the comb 300 further comprises a protection layer 324 covering the outer surface of the photocatalytic material 222. The protection layer 324 has a function of protecting the photocatalytic material 222 from wear or damage. The protection layer 324 can be made of plastic or the like.

FIG. 6 depicts a schematic diagram of a comb 400 according to yet another embodiment of the present invention. As shown in FIG. 6, the light source 430 is positioned in the body 110, and the comb 400 further comprises a light guide 440 connected to the light source 430 for guiding the light beams from the light source 430 into the tines 420. Specifically, the light guide 440 comprises a plurality of optical fibers 442 respectively extending within the tines 420. Since the optical fibers 442 are generally flexible, the tines 420 are bendable and therefore gentle to hair and scalp, minimizing any pulling or tearing of hair.

In the disclosure herein, operations of comb(s) may be described with reference to method embodiment(s) for illustrative purposes. However, it should be appreciated that the operations of the combs and the implementations of the methods in the disclosure may be independent of one another. That is, the disclosed comb embodiments may operate according to other methods and the disclosed method embodiments may be implemented through other combs.

It should be readily appreciated by the skilled in the art that various modifications and variations can be made to the embodiments of the invention illustrated and described herein without departing from the scope and spirit of the invention. It is intended that such modifications and variations be encompassed by the appended claims.

What is claimed is:

1. A comb, comprising:
a body;
a tine extending from said body, said tine being covered or partially covered by photocatalytic material, and
a light source positioned in said comb, said light source providing light beams to the surface of said photocatalytic material to accelerate reactions of generating radicals from air; and

2. (canceled)

3. The comb of claim 1, wherein said photocatalytic material comprises at least one opening.

4. The comb of claim 1, wherein said light source is positioned in said tine and comprises at least one organic light emitting diode.

5. The comb of claim 1, wherein said light source is positioned in said body and said comb further comprising:
a light guide connected to said light source for guiding said light beams from said light source into said tine.

6. The comb of claim 1, wherein the outer surface of said photocatalytic material is covered by a protection layer.

7. The comb of claim 1, wherein said photocatalytic material comprises at least one of: TiO₂, ZnO, CeO₂, ZnO₂, SnO₂, SbO₄, CdS and ZnS.

8. The comb of claim 1, wherein said light source comprises at least one ultra violet light source.

9. The comb of claim 1, wherein said radicals comprises hydroxyl radicals.

10. (canceled)
